(19) United States
(12) Patent Application Publication
(10) Pub. No.: US 2016/0012480 A1
(43) Pub. Date: Jan. 14, 2016

(54) Targeted Electronic Commerce Based on Historical Purchasing Data

(71) Applicant: MASTERCARD INTERNATIONAL INCORPORATED, Purchase, NY (US)

(72) Inventors: Ashutosh Sharan, Gurgaon (IN); Avyaktanand Tiwary, Gurgaon (IN); Jitender Balyan, Sydney (AU)

(21) Appl. No.: 14/791,883

(22) Filed: Jul. 6, 2015

(30) Foreign Application Priority Data
Jul. 9, 2014 (SG) 10201403975R

(51) Int. Cl. G06Q 30/02; G06F 17/30

(52) U.S. Cl. CPC G06Q 30/0255; G06F 17/3053; G06F 17/30528; G06F 17/30867

(57) ABSTRACT

An electronic commerce method is provided. The electronic commerce method comprises storing transaction data of a plurality of account holders, each of the transaction data relating to a transaction initiated by the respective account holder with a merchant; determining a candidate group of merchants based on the transaction data; and providing at least one purchasing opportunity with at least one of the merchants in the determined group of merchants to at least one account holder, the opportunity promoting a transaction.

### FIELD

Various embodiments herein relate generally to electronic commerce and more particularly to targeted electronic commerce (e-commerce) based on historical purchasing data.

### BACKGROUND

This section provides background information related to the present disclosure which is not necessarily prior art.

Merchants, advertising companies and financial institutions are continually striving for greater customer transactions, whether in frequency or volume. Great effort is taken to promote and advertise their goods and/or services to achieve this goal.

Promotion and advertising generally have relied on traditional modes of communication such as media broadcasts and printed articles.

A problem with these conventional channels is that such advertisement efforts tend to be ineffective, in that the advertisements are not targeted at specific groups of customers who are more likely to transact with them.

Accordingly, it would be desirable to ascertain that a customer is likely to transact with a particular merchant, so as to identify a group of customers for whom advertisement effort should be expended.

### SUMMARY

This section provides a general summary of the disclosure, and is not a comprehensive disclosure of its full scope or all of its features. Aspects and embodiments of the disclosure are also set out in the accompanying claims.

Various embodiments provide an electronic commerce method generally comprising storing transaction data of a plurality of account holders, each of the transaction data relating to a transaction initiated by the respective account holder with a merchant; determining a candidate group of merchants based on the transaction data; and providing at least one purchasing opportunity with at least one of the merchants in the determined group of merchants to at least one account holder, the opportunity promoting a transaction.

In an embodiment, the electronic commerce method further comprising generating an indicia based on a merchant in the determined group of merchants, the indicia providing a likelihood that the account holder initiates a transaction with the merchant in the determined group of merchants.

In an embodiment, the electronic commerce method further comprising generating another indicia based on another merchant in the determined group of merchants, the other indicia providing a likelihood that the account holder initiates a transaction with the other merchant in the determined group of merchants.

In an embodiment, the electronic commerce method further comprising ranking the merchants in the determined group of merchants based on both the generated indicia.

In an embodiment, the opportunity promoting a transaction provided to the account holder follows a sequence that is based on the ranking of the merchants.

In an embodiment, determining the group of merchants based on the transaction data comprises obtaining transaction data of a plurality of account holders in a database, each of the transaction data of the plurality of account holders relating to a transaction initiated by one of the plurality of account holders in the database with a merchant; generating a list of merchants based on the transaction data of the plurality of account holders; and removing at least one merchant from the generated group of merchants, based on a filtering criteria applied on the transaction data of the plurality of account holders, so that the information provided promotes a transaction with the remaining merchants from the determined group of merchants.

In an embodiment, the filtering criteria applied on the transaction data of the plurality of account holders comprises determining if a merchant, related to the transaction data of the plurality of account holders, belongs to a group of merchants with which a number of account holders transact, the number being one which is above a threshold.

In an embodiment, the threshold is a predetermined portion of the plurality of account holders in the database.

In an embodiment, the electronic commerce method further comprising receiving an input from the account holder, the input indicating an account number of the account holder.

In an embodiment, the opportunity promoting a transaction is provided in response to the input.

In an embodiment, the account holder is a customer who initiates the transaction with the merchant.

In an embodiment, the transaction is a payment transaction between the merchant and the account holder.

Various embodiments provide a server for providing information generally comprising at least one processor; and at least one memory including computer program code; the at least one memory and the computer program code configured to, with the at least one processor, cause the server at least to store transaction data of a plurality of account holders, each of the transaction data relating to a transaction initiated by the respective account holder with a merchant, determine a candidate group of merchants based on the transaction data; and provide at least one purchasing opportunity with at least one of the merchants in the determined group of merchants to at least one account holder, the opportunity promoting a transaction.

Various embodiments provide a computer-readable storage medium having stored thereon computer program code which when executed by a computer causes the computer to execute a method in accordance with an embodiment.

Various embodiments provide a computer program comprising software code adapted to perform a method in accordance with an embodiment.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Example disclosed embodiments will be better understood and readily apparent to one of ordinary skill in the art from the following written description, by way of example only, and in conjunction with the drawings, in which:

FIG. 1 is a block diagram of a system for implementing purchase transactions;

FIG. 2 is a schematic diagram of a wireless device that may be used in FIG. 1;

FIG. 3 is a schematic diagram of a computer system that may be used in FIG. 1;

FIG. 4 is a flow diagram illustrating a generalized method in accordance with a disclosed embodiment; and

FIGS. 5(a)-5(d) are flow diagrams illustrating exemplary operations that are performed in several of the components in the system of FIG. 1.

### DETAILED DESCRIPTION

Embodiments will be described, by way of example only, with reference to the drawings. Like reference numerals and characters in the drawings refer to like elements or equivalents.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “scanning”, “calculating”, “determining”, “replacing”, “generating”, “initializing”, “outputting”, “establishing”, “receiving”, “sending”, “identifying”, “transmitting”, “comparing”, “extracting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program and the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer-readable medium. The computer-readable medium may include storage devices such as magnetic or optical disks, memory chips, or other storage devices suitable for interfacing with a general purpose computer. The computer-readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of a method in accordance with a disclosed embodiment.

The disclosed embodiments may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Some disclosed embodiments relate to an apparatus, a method, a corresponding computer program and computer-readable storage medium that can provide information to the holder of the account, e.g. a customer. The information promotes a transaction with at least one of the clients, e.g. a merchant, in a determined group.

Some disclosed embodiments can also be used in non-financial electronic transactions (i.e. transactions that do not involve monetary payment in exchange for goods and/or services). An example of a non-financial electronic transaction is the redemption of customer loyalty rewards (e.g. frequent flyer miles, credit card points).

For example, information which promotes redemption with a particular merchant can be provided to an account holder based on the past redemption data relating to the account holder's previous redemption. In this way, the account holder can be informed of promotions that are of interest to him/her.

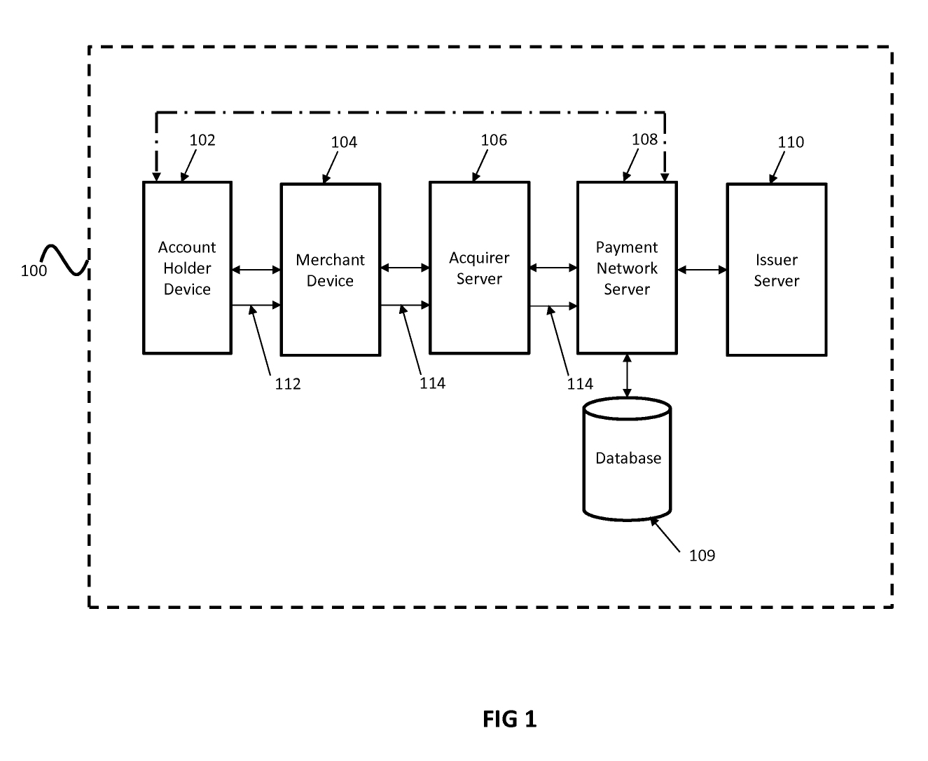

FIG. 1 illustrates a block diagram of a transaction system 100 within which a credit or debit card transaction can be implemented.

The system 100 comprises an account holder device 102 (e.g. customer) in communication with a merchant device 104. In another embodiment, the account holder device 102 may be in direct communication with a payment network server 108, without having to communicate with the merchant device 104.

The merchant device 104 is in communication with an acquirer server 106. The acquirer server 106, in turn, is in communication with a payment network server 108. The payment network server 108, in turn, is in communication with an issuer server 110.

Use of the term ‘server’ herein can mean a single computing device or a plurality of interconnected computing devices which operate together to perform a particular function. That is, the server may be contained within a single hardware unit or be distributed among several or many different hardware units.

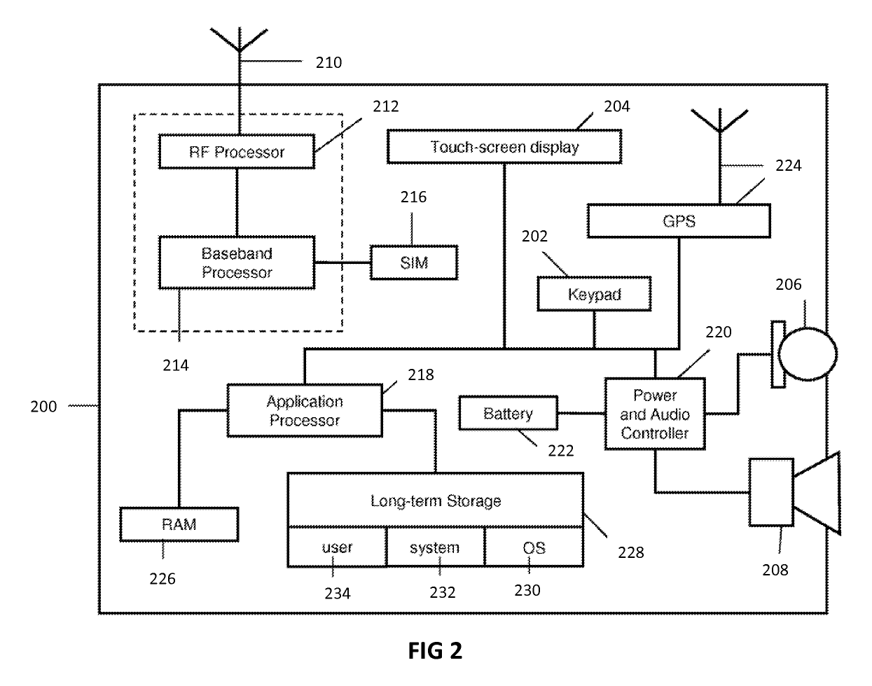

The account holder device 102 typically is associated with a customer who is a party to a transaction that occurs between the account holder device 102 and the merchant device 104 through a transaction request message 112. The account holder device 102 may be a fixed (wired) computing device or a wireless (portable) computing device. In specific implementations, the account holder device 102 may be a handheld or portable or mobile device carried or used by the customer (e.g. FIG. 2), or may refer to other types of electronic devices such as a personal computer, a land-line telephone, an interactive voice response (IVR) system, and the like. The mobile device may be a device, such as a mobile phone, a laptop computer, a personal digital computer (PDA), a mobile computer, a portable music player (such as an iPod™ and the like). An exemplary wireless computing device is described below with reference to FIG. 2.

The merchant device 104 typically is associated with the merchant who is also a party to the transaction that occurs between the account holder device 102 and the merchant device 104 through the transaction request message 112. The merchant device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The acquirer server 106 generally is associated with an acquirer who may be an entity (e.g. a company or organization) which issues (e.g. establishes, manages, administers) an account (e.g. a financial bank account) of the merchant. Examples of the acquirer include a bank and/or other financial institution. As foreshadowed above, the acquirer server 106 may include one or more computing devices that are used to establish communication with another server by exchanging messages with and/or passing information to the other server.

The payment network server 108 typically is associated with a payment facilitator. For example, the payment network server 108 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions.

The issuer server 110 generally is associated with an issuer and may include one or more computing devices that are used to perform a payment transaction. The issuer may be an entity (e.g. a company or organization) which issues (e.g. establishes, manages, administers) an account (e.g. a financial bank account) of an account holder or an account owner.

In a disclosed embodiment, the payment network server 108 may be configured to communicate with, or may include, a database 109. The database 109 stores data corresponding to each account issued by the issuer. Examples of the data include a password, an account holder name and address, a credit limit and transaction data relating to one or more transactions performed by the account holder on the account. In some disclosed embodiments, at least one of the transaction data may relate to a transaction initiated by the customer with a plurality of merchants that are different from the identified merchant.

In an example, during a transaction, the transaction request message 112 is generated at the account holder device 102. The transaction request message 112 is generated by the account holder device 102 in response to the customer making a selection of a good and/or service to be purchased from the merchant. Therefore, the transaction request message 112 relates to a transaction between the customer and the merchant. In specific implementations, the transaction may be performed via a website of the merchant.

The transaction request message 112 may include transaction data and/or data relating to the customer (i.e. customer data). Each transaction data relates to a transaction and identifies the customer and the merchant, generally by way of account identifiers of each associated with the issuer and acquirer respectively. Further, the transaction data may also identify the goods and/or services to be purchased. The transaction data may further identify a value or price of the goods and/or services. The transaction data may also indicate a time and date at which the transaction was initiated.

The transaction request message 112 is sent from the account holder device 102 to the merchant device 104. In a disclosed embodiment, for example where the transaction is being performed at the website of the merchant, the account holder device 102 and the merchant device 104 are in communication with a network, such as, the Internet (not shown for the sake of simplicity). In this example, the transaction request message 112 is sent from the account holder device 102 to the merchant device 104 via the network.

A request message 114 may be generated at the merchant device 104 which acts to request the issuer at the issuer server 110 to authorize or perform the transaction. In a disclosed embodiment, the request message 114 is a payment request message or a modified transaction request message. In a disclosed embodiment, the transaction is done via the Internet and the request message 114 may include merchant data. The merchant data may indicate the address of the merchant's website and/or the type of the transaction.

The request message 114 is sent from the merchant device 104 to the acquirer server 106. The request message 114 includes the transaction data and thus identifies the customer and the merchant. The transaction data in the request message 114 may serve as a request for the issuer to authorize the transaction. In other words, the acquirer server 106 may be permitted to obtain the transaction amount on behalf of the merchant.

The request message 114 is forwarded (not illustrated) from the acquirer server 106 to the payment network server 108. In a disclosed embodiment, the acquirer server 106 may not conduct any processing on or with the request message 114 and, instead, may merely receive the request message 114 from the merchant device 104 and forward it to the payment network server 108.

The request message 114 is received at the payment network server 108. In this way, the payment network server 108 is informed of the transaction and that the merchant would like to obtain authorization of the transaction. In a disclosed embodiment, the payment network server 108 stores the request message 114 in the database 109. In this manner, transaction data of a customer may be stored in the database 109.

As mentioned above, the role of the payment network server 108 is to facilitate communication between the acquirer server 106 and the issuer server 110. Therefore, the payment network server 108 may serve as a means through which the acquirer server 106 may communicate with the issuer server 110 in order that payments and authentication may be performed. In a similar fashion, the payment network server 108 may be informed of every transaction between the acquirer server 106 and the issuer server 110.

It follows from the above that the payment network server 108, and more particularly the database 109, form a repository of transaction data for many customers and many merchants.

FIG. 2 is a schematic of an exemplary wireless computing device 200 that can be utilized to implement the account holder device 102 of FIG. 1 and/or the merchant device 104 in FIG. 1.

The wireless device 200 comprises a keypad 202, a touch-screen 204, a microphone 206, a speaker 208 and an antenna 210. The wireless device 200 is capable of being operated by a user to perform a variety of different functions, such as, for example, hosting a telephone call, sending an SMS message, browsing the Internet, sending an email and providing satellite navigation.

The wireless device 200 comprises hardware to perform communication functions (e.g. telephony, data communication), together with an application processor and corresponding support hardware to enable the wireless device 200 to have other functions, such as, messaging, Internet browsing, email functions and the like. The communication hardware is represented by the RF processor 212 which provides an RF signal to the antenna 210 for the transmission of data signals, and the receipt therefrom. Additionally provided is a baseband processor 214, which provides signals to and receives signals from the RF Processor 212. The baseband processor 214 also interacts with a subscriber identity module (or SIM) 216, as is well known in the art. The communication subsystem enables the wireless device 200 to communicate via a number of different communication protocols including 3G, 4G, GSM, WiFi, Bluetooth™ and/or CDMA. The communication subsystem of the wireless device 200 is beyond the scope of the present disclosure.

The keypad 202 and the touch-screen 204 are controlled by an application processor 218. A power and audio controller 220 is provided to supply power from a battery 222 to the communication subsystem, the application processor 218, and other hardware. The power and audio controller 220 also controls input from the microphone 206, and audio output via the speaker 208. Also provided is a global positioning system (GPS) antenna and associated receiver element 224 which is controlled by the application processor 218 and is capable of receiving a GPS signal for use with a satellite navigation functionality of the wireless device 200.

In order for the application processor 218 to operate, various different types of memory are provided. Firstly, the wireless device 200 includes Random Access Memory (RAM) 226 connected to the application processor 218 into which data and program code can be written and read from at will. Code placed anywhere in RAM 226 can be executed by the application processor 218 from the RAM 226. RAM 226 represents a volatile memory of the wireless device 200.

Secondly, the wireless device 200 is provided with a long-term storage 228 connected to the application processor 218. The long-term storage 228 comprises three partitions, an operating system (OS) partition 230, a system partition 232 and a user partition 234. The long-term storage 228 represents a non-volatile memory of the wireless device 200.

In the present example, the OS partition 230 contains the firmware of the wireless device 200 which includes an operating system. Other computer programs may also be stored on the long-term storage 228, such as application programs, and the like. In particular, application programs which are mandatory to the wireless device 200, such as, in the case of a smartphone, communications applications and the like are typically stored in the system partition 232. The application programs stored on the system partition 232 would typically be those which are bundled with the wireless device 200 by the device manufacturer when the wireless device 200 is first sold.

Application programs which are added to the wireless device 200 by the user would usually be stored in the user partition 234.

As stated, the representation of FIG. 2 is schematic. In practice, the various functional components illustrated may be substituted into one and the same component. For example, the long-term storage 228 may comprise NAND flash, NOR flash, a hard disk drive or a combination of these.

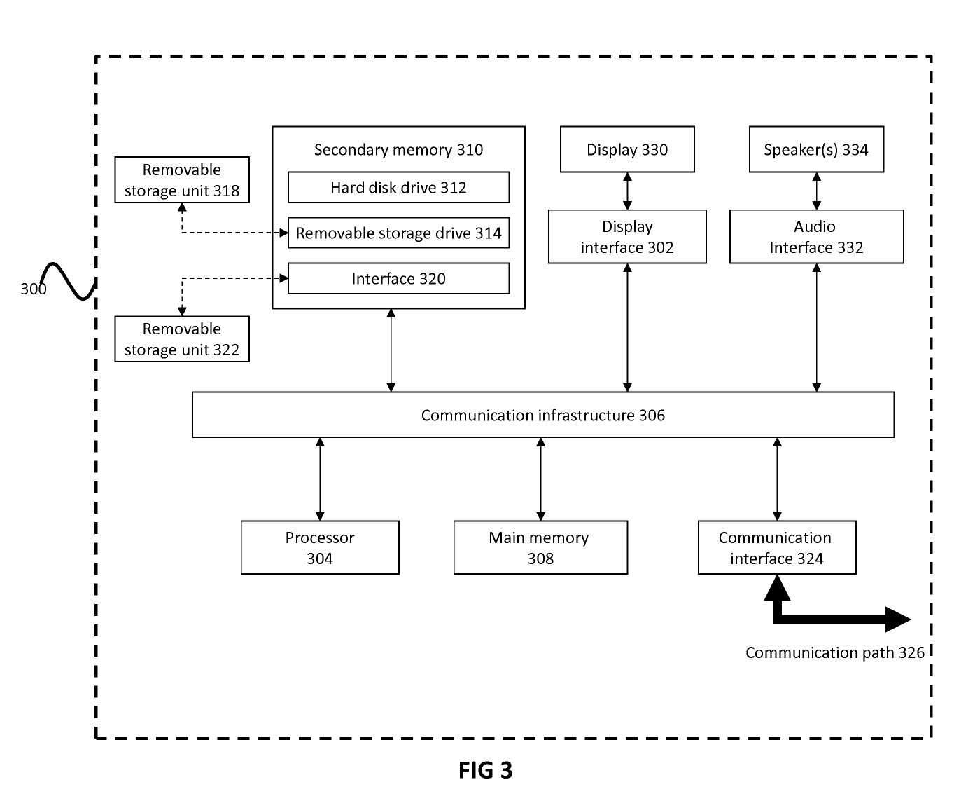

FIG. 3 depicts an exemplary computing device 300 where one or more such computing devices 300 may be used for the acquirer server 106, the payment network server 108 or the issuer server 110. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage unit 318 in a well-known manner. The removable storage unit 318 may include a floppy disk, magnetic tape, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, and other removable storage units 322 and interfaces 320 which allow software and data to be transferred from the removable storage unit 322 to the computing device 300.

The computing device 300 also includes at least one communication interface 324. The communication interface 324 allows software and data to be transferred between computing device 300 and external devices via a communication path 326. In various disclosed embodiments, the communication interface 324 permits data to be transferred between the computing device 300 and a data communication network, such as a public data or private data communication network. The communication interface 324 may be used to exchange data between different computing devices 300 which such computing devices 300 form part of an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface 324 via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. A computer readable medium can include magnetic media, optical media, or other recordable media, or media that transmits a carrier wave or other signal. These computer program products are devices for providing software to the computing device 300.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computing device 300.

Software may be stored in a computer program product and loaded into the computing device 300 using the removable storage drive 314, the hard disk drive 312, or the interface 320. Alternatively, the computer program product may be downloaded to the computing device 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In an implementation, the payment network server 108 may be generally described as a physical device comprising at least one processor and at least one memory including computer program code. The at least one memory and the computer program code are configured to, with the at least one processor, cause the physical device to perform the operations below.

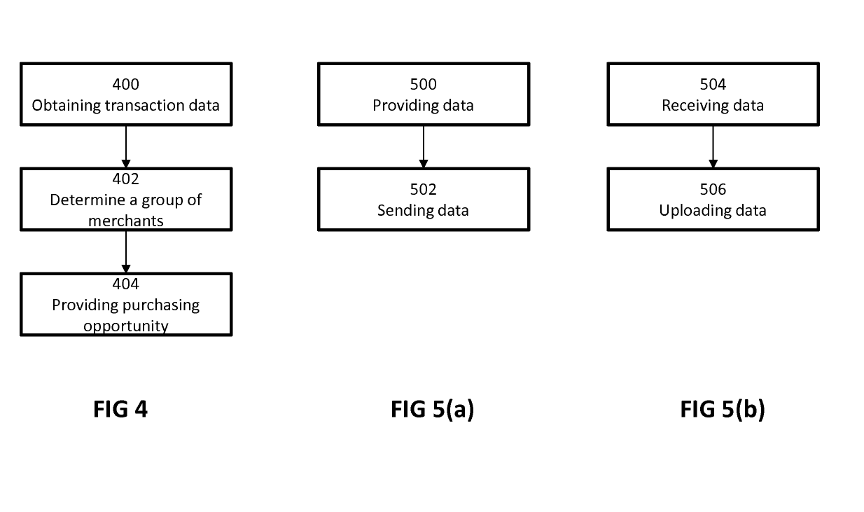

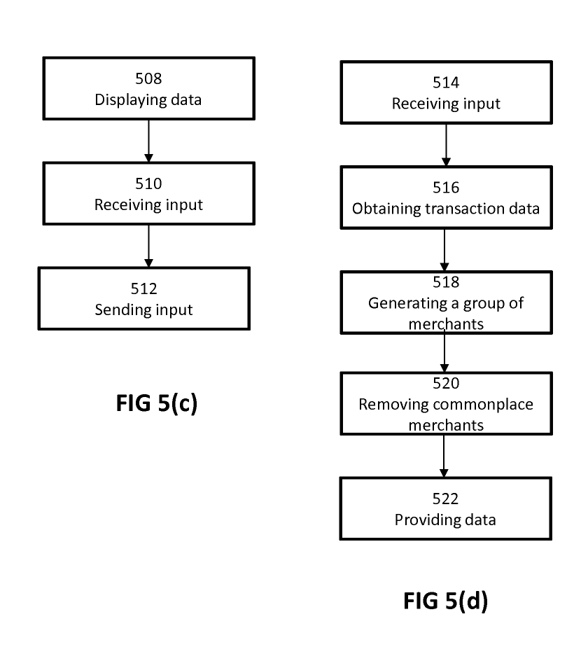

For example, either of the methods of the following FIGS. 4 and 5 may be implemented as software and stored in a non-transitory fashion in the secondary memory 310 or the removable storage units 318, 322 of the computing device 300. Further detail on the methods shown in FIGS. 4 and 5 are described below.

FIG. 4 shows flow diagram of a method performed by at least one of the above-described devices in FIG. 1 in accordance with a first embodiment. When implemented, the method provides a purchasing opportunity to the holder of the account, such as a customer. The opportunity promotes a transaction with at least one of the clients in a determined group. The flow diagram is now described with reference to FIG. 1.

At operation 400, transaction data is obtained from the database 109. The holder of the account (or account holder) typically is a customer of a merchant. In other words, the transaction data relates to the transactions initiated by the customer. Each of the transaction data generally refers to a transaction between the customer and a merchant.

At operation 402, a group of merchants are determined at the payment network server 108 based on the transaction data of the customer. In a specific implementation of the operation 402, filtering criteria may be applied to all participating merchants to select the group of merchants with which the customer is most likely to transact.

By way of example, a customer, Mary, who has previously transacted with a identified merchant, AA, also spent at other merchants. The other merchants are BB, CC, DD and EE.

A filtering criteria is applied on transaction data with these other merchants to find out if a percentage (for example, 5% or 10%) of the total number of account holders in a database transacted at these merchants. Subsequent to applying the filtering criteria, the merchants DD and EE are removed, so that the group of merchants, e.g. BB and CC remain. In other words, customers who spend at any one of this group of merchants (in this instance, BB and CC) may be likely to spend at AA.

It follows from operations 400 and 402 that if a customer (e.g. John) has previously transacted at merchant BB, it will be determined that John is likely to transact with the group of merchants, AA and CC. In other words, it may be seen that customers who have transacted at a particular merchant may have similar interests, namely Mary and John in this case.

As mentioned above, each of the transaction data relates to one transaction between the customer and a merchant. By way of example, the payment network server 108 may be configured to process the transaction data to determine a group of merchants with which the customer is most likely to transact.

At operation 404, data is provided from the payment network server 108 to the holder of the account. The data promotes a purchasing opportunity with at least one of the merchants in the group determined at operation 402. The data may represent a marketing or advertising nature. The data may relate to a specific good and/or service to be purchased at the merchant. The data may further have a time period during which the information is valid.

In this manner, a customer will be informed of on-going promotions at the merchants that are of interest to him/her.

FIGS. 5(a)-5(d) show flow diagrams of a method performed by at least one of the above-described devices shown in FIG. 1. The following describes FIGS. 5(a), 5(b), 5(c) and 5(d) in turn.

The operations of FIG. 5(a) are performed by the merchant device 104, as described in FIG. 1. At operation 500, data is generated at the merchant device 104. In a specific implementation, the advertisement, marketing material or promotion are created, designed or generated by the merchant using the merchant device 104.

By way of example, a merchant, ZZ, may generate advertising data promoting or advertising its goods and/or services. The advertising data may offer a customer to purchase a good at ZZ at a discounted price, and indicate that the advertising data is valid over a period of five months.

At operation 502, the data is sent from the merchant device 104 to the payment network server 108. In an embodiment, the merchant device 104 and the payment network server 108 are in communication with a network, such as, the Internet. In this example, the information is sent from the account holder device 102 to the merchant device 104 via the network.

The operations of the payment network server 108, as described above in FIG. 1, will now be described with reference to FIG. 5(b).

At operation 504, the data output from operation 502 of FIG. 5(a) is received at the payment network server 108. By way of example, the advertisement data is received at a computer server hosted by MasterCard®. In this way, the payment facilitator, MasterCard®, is informed that merchant ZZ is offering to sell a good at a discounted price over the next five months.

At operation 506, the data is uploaded by the payment network server 108. In an implementation, the data is uploaded to a website hosted by the payment facilitator so as to inform viewers of the website. In this example, the advertisement data is uploaded to a website hosted by MasterCard® via the network.

The operations of FIG. 5(c) are performed by the account holder device 102, as described in FIG. 1. At operation 508, the account holder device 102 is typically used to display the data uploaded by the payment network server 108 from operation 506 of FIG. 5(b). In this manner, the customer may be informed of on-going advertisement via the uploaded data.

In the example, a customer, John, may browse the website hosted by MasterCard® and view the advertisement data related to merchant ZZ. In this manner, John is informed that merchant ZZ is offering to sell a good at a discounted price over the next five months. However, the data that is provided to John is not based on the group of merchants with which he is most likely to transact. In other words, the uploaded data that a customer typically obtains on a website is generic and is not specific based on his spending behavior.

It is also possible for the customer to be informed of on-going advertisement via other means. For example, the customer may be informed through above-the-line (ATL) advertisement via which advertisement data is broadcast and published to the public through other forms of media such as television, camera, radio, or print.

At operation 510, the account holder device 102 is configured to receive an input from a customer who is using the account holder device 102. In an implementation, the website provides an option to enter an input so as to obtain customized data specific to the customer. The customized data may relate to promotions at merchants of interest to the customer. The input may be entered using an input device of the account holder device 102. The input device typically is a keyboard, a keypad or a touch screen. The input serves to identify the customer to the payment facilitator.

The input may include the name of the account holder, the primary account number (or “PAN”) and the date of expiry of the account (if applicable).

The PAN refers to a number of digits (or characters) which identify an account issued by an issuer (for example, a bank). For example, in some embodiments an account (e.g. credit account, debit account, pre-paid account) is issued by an issuer pursuant to the MasterCard® International Incorporated rules, and the PAN may be a twelve to nineteen-digit string that identifies both the issuer (e.g. which may be based on the first few digits of the string, for example, the first five to ten digits) and the specific account (e.g. which may be based on some or all of the remaining digits). The PAN is typically utilized to route and process transactions that involve the account.

Following the example, on the same website or a different pop-up website, John may be prompted to fill in his account data. He may fill in data of an account including the name to which the account was registered, the PAN and the date of expiry of the account (if applicable). John may also be prompted to enter the security data for the account, for example, the Card Verification Value (“CVV”) or Card Security Code (“CSC”) or Card Verification Code (“CVC”) from a payment card. Such data identifying the account is included in the account data.

At operation 512, the input is sent from the account holder device 102 to the payment network server 108. In an implementation, the account holder device 102 does not perform any further processing to the input and, instead, may merely receive the input and send it to the payment network server 108.

The operations of the payment network server 108, as described above in FIG. 1, will now be described with reference to FIG. 5(d).

At operation 514, the input from operation 512 of FIG. 5(c) is received at the payment network server 108. In this way, the payment network server 108 is informed that a customer would like to obtain customized data.

In an implementation, account data, such as the name of the account holder, the PAN and the date of expiry of the account, may be stored in the database 109.

Upon receiving the input at operation 514, the payment network server 108 is further configured to compare the input with the account data. In other words, the payment network server 108 identifies the customer if the input received from the account holder device 102 matches or corresponds to the account data.

Following the example, on the website, John may be prompted to fill in a complete PAN. If so, the input is then compared by the payment network server 108 to the complete PAN. On the other hand, the website may request that the first, third and sixth characters of the PAN be input. In this case, the input is then compared by the issuer server 110 to the appropriate portions of the preset or registered password.

In another instance, where the input includes a software or security token, cryptography techniques may be used to determine the identity of the customer. For example, the cryptography techniques can be used to determine if the token in the input was generated by a valid token generator.

At operation 516, transaction data belonging to the customer identified at operation 514 is obtained. It is possible for the payment network server 108 to find out the merchant or merchants with which the holder of the account has transacted based on the transaction data.

At operation 518, a group of merchants is generated based on the transaction data belonging to the holders of accounts in the database 109. Further, the group of merchants include merchants whom the customers had prior transactions.

At operation 520, at least one merchant from the generated group of merchants is removed based on a filtering criteria applied on the transaction data of the plurality of holders. The filtering criteria removes commonplace merchants from the group of merchants generated at operation 518. That is, each merchant in the group of merchants may be a commonplace merchant or a non-commonplace merchant. A commonplace merchant is a merchant with which holders of accounts above a threshold have transacted. The threshold may be a percentage of the total number of accounts in a database. Examples of a commonplace merchant may include supermarket chains, department stores, fast food chains, etc.

The remaining merchants in the group of merchants are merchants which are of interest to the customer. As such, removing commonplace merchants typically identifies affinity merchants which are relevant to determining a likelihood that a holder of an account may initiate a transaction with the identified client. Advantageously, removing commonplace merchants so as to determine the group of merchants with which the customer may transact, even when the holder of an account has not performed prior transactions with the identified merchant. This is possible because the likelihood is determined based on the transaction data relating to transactions with the group of merchants.

In an implementation, an indicia is generated for each of the merchants in the group. Each indicia provides a likelihood that the customer is likely to initiate a transaction with the merchant. Subsequently, the merchants may be ranked based on the generated indicia. The ranking of the merchants may be based on the transaction data of a customer. For example, if the customer has previously initiated more transactions with merchants in the fashion industry, this will mean that a higher indicia will be generated for a fashion merchant than an automobile industry in the determined list.

At operation 522, the payment network server 108 determines if any of the merchants determined at 520 has an on-going promotion. If it is determined that there is an on-going promotion from at least one of these merchants, the data is provided to the account holder device 102. The data from the merchant is provided to the holder of the account in a sequence based on the ranking of the clients at operation 520. Following the above example, the data pertaining to the fashion merchant will be provided first, before the data pertaining to the automobile industry.

The methods of FIGS. 4 and 5 have been described above with reference to the account holder device 102, the merchant device 104 and the payment network server 108 of FIG. 1. However, in alternative embodiments, it is possible for the account holder to directly access the payment network server 108 in order to initiate a transaction. In other words, a transaction may be initiated without the account holder device 102 having to communicate with the merchant device 104.

It should be appreciated that the functions and/or steps and/or operations described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

It should further be appreciated that the exemplary embodiments are only examples, and are not intended to limit the scope, applicability, operation, or configuration of the disclosure in any way. Rather, the foregoing detailed description will provide those skilled in the art with a convenient road map for implementing an exemplary disclosed embodiment, it being understood that various changes may be made in the function and arrangement of elements and methods of operation described in an exemplary embodiment without departing from the scope of the disclosure as set forth in the appended claims.

1. An electronic commerce method comprising:
storing transaction data of a plurality of account holders, each of the transaction data relating to a transaction initiated by the respective account holder with a merchant;
determining, by a computing device, a candidate group of merchants based on the transaction data; and
providing at least one purchasing opportunity with at least one of the merchants in the determined group of merchants to at least one account holder, the opportunity promoting a transaction.

2. The electronic commerce method according to claim 1, further comprising:
generating, by the computing device, an indicia based on a merchant in the determined group of merchants, the indicia providing a likelihood that the account holder initiates a transaction with the merchant in the determined group of merchants.

3. The electronic commerce method according to claim 2, further comprising:
generating, by the computing device, another indicia based on another merchant in the determined group of merchants, the other indicia providing a likelihood that the account holder initiates a transaction with the other merchant in the determined group of merchants.

4. The electronic commerce method according to claim 3, further comprising:
ranking, by the computing device, the merchants in the determined group of merchants based on both the generated indicia.

5. The electronic commerce method according to claim 4, wherein the opportunity promoting a transaction provided to the account holder follows a sequence that is based on the ranking of the merchants.

6. The electronic commerce method according to claim 1, wherein determining the group of merchants based on the transaction data comprises:
obtaining transaction data of a plurality of account holders in a database, each of the transaction data of the plurality of account holders relating to a transaction initiated by one of the plurality of account holders in the database with a merchant;
generating a list of merchants based on the transaction data of the plurality of account holders; and
removing at least one merchant from the generated list of merchants, based on a filtering criteria applied on the transaction data of the plurality of account holders, so that the purchasing opportunity promotes a transaction with the remaining merchants from the determined group of merchants.

7. The electronic commerce method according to claim 6, wherein the filtering criteria applied on the transaction data of the plurality of account holders comprises:
determining if a merchant, related to the transaction data of the plurality of account holders, belongs to a group of merchants with which a number of account holders transact, the number being one which is above a threshold.

8. The electronic commerce method according to claim 7, wherein the threshold is a predetermined portion of the plurality of account holders in the database.

9. The electronic commerce method according to claim 1, further comprising receiving an input from the account holder, the input indicating an account number of the account holder; and
wherein the opportunity promoting a transaction is provided in response to the input.

10. (canceled)

11. The electronic commerce method according to claim 1, wherein the account holder is a customer who initiates the transaction with the merchant; and/or
wherein the transaction is a payment transaction between the merchant and the account holder.

12. (canceled)

13. A server for providing information, comprising:
at least one processor; and
at least one memory including computer program code;
the at least one memory and the computer program code configured to, with the at least one processor, cause the server at least to:
store transaction data of a plurality of account holders, each of the transaction data relating to a transaction initiated by the respective account holder with a merchant, and determine a candidate group of merchants based on the transaction data; and
provide at least one purchasing opportunity with at least one of the merchants in the determined group of merchants to at least one account holder, the opportunity promoting a transaction.

14. The server according to claim 13, further configured to generate an indicia based on a merchant in the determined group of merchants, the indicia providing a likelihood that the account holder initiates a transaction with the merchant in the determined group of merchants.

15. The server according to claim 14, further configured to generate another indicia based on another merchant in the determined group of merchants, the other indicia providing a likelihood that the account holder initiates a transaction with the other merchant in the determined group of merchants.

16. The server according to claim 15, further configured to rank the merchants in the determined group of merchants based on both the generated indicia.

17. The server according to claim 16, wherein the opportunity promoting a transaction provided to the account holder follows a sequence that is based on the ranking of the merchants.

18. The server according to claim 13, further configured to:
obtain transaction data of a plurality of account holders in a database, each of the transaction data of the plurality of account holders relating to a transaction initiated by one of the plurality account of holders in the database with a merchant;
generate a list of merchants based on the transaction data of the plurality of account holders; and
remove at least one merchant from the generated list of merchants, based on a filtering criteria applied on the transaction data of the plurality of account holders, so that the purchasing opportunity promotes a transaction with the remaining merchants from the determined group of merchants.

19. The server according to claim 18, wherein the filtering criteria applied on the transaction data of the plurality of holders comprises:
determining if a merchant, related to the transaction data of the plurality of account holders, belongs to a group of merchants with which a number of holders of accounts transact, the number being one which is above a threshold.

20. The server according to claim 19, wherein the threshold is a predetermined portion of the plurality of account holders in the database.

21. The server according to claim 13, further configured to receive an input from the account holder, the input indicating an account number of the account holder;
wherein the opportunity promoting a transaction is provided in response to the input.

22.-24. (canceled)

25. A non-transitory computer-readable storage medium having stored thereon computer program code which, when executed by a processor, causes the processor to:
store transaction data of a plurality of account holders, each of the transaction data relating to a transaction initiated by the respective account holder with a merchant;
determine a candidate group of merchants based on the transaction data; and
provide at least one purchasing opportunity with at least one of the merchants in the determined group of merchants to at least one account holder, the opportunity promoting a transaction.

26. (canceled)
